(19) United States
(12) Patent Application Publication
(10) Pub. No.: US 2012/0071055 A1
(43) Pub. Date: Mar. 22, 2012

(54) Insulated Above Ground Pool

(76) Inventor: Theodor Franciscus Gillebaard, Laguna Niguel, CA (US)

(21) Appl. No.: 12/977,572

(22) Filed: Dec. 23, 2010

Related U.S. Application Data
(60) Provisional application No. 61/289,502, filed on Dec. 23, 2009.

(51) Int. Cl. B32B 15/14; B32B 37/06; B32B 5/26

(52) U.S. Cl. 442/234; 156/272.2

(57) ABSTRACT

An above-ground pool which consists of a plurality of layers of which there is an inner woven reinforced vinyl layer, a second, foil-laminated, metalized layer which is entrapped between a third woven reinforced vinyl layer. The three layers are then sealed together to form a watertight structure. The inner and outer layer is designed to be able to withstand forces which a typical container would experience. The core of the material is polyester woven which is then encased in durable vinyl. The layers are all combined together to form a water-tight seal by using radio frequency energy to weld the inner and outer layer together to form a permanent seal while the foil laminated, metalized layer is entrapped between the inner and outer layer.

### CROSS-REFERENCE TO RELATED APPLICATION

U.S. provisional application Ser. No. 61/289,502 dated Dec. 23, 2009 the contents of which are hereby incorporated by reference.

### BACKGROUND

Above-the-ground swimming pools currently available are commonly comprised of sheet metal panels. Alternatively, portable swimming pool structures comprised of an air-filled pontoon are available. Although such products have proven generally suitable for their intended purposes, they possess inherent deficiencies which detract from their overall effectiveness. Sheet metal panels are heavy to move around, time consuming to assemble, and subject to corrosion. Air filled pontoons are subject to rupture and leakage.

Furthermore, considering the current needs of the environment around us, the need to conserve energy and efficiency are of paramount importance. In addition to energy savings, today's above-ground pools fail to adequately conserve heat which may result in less hours of operable use, higher energy costs, and generally less consumer enjoyment.

### FIELD OF THE INVENTION

The present invention relates generally to recreational devices and more particularly to an above-the-ground, portable swimming pool specifically adapted to be easily and quickly assembled and disassembled.

### BRIEF DESCRIPTION OF THE DRAWINGS

FIG. 1 is a perspective view of a preferred embodiment of an insulated above ground pool.

FIG. 2 shows a cross-section of a preferred embodiment with a metalized layer disposed between two polyester layers.

FIG. 3 illustrates the insertion of metalized insulating layer 16 between the inner and outer vinyl layer 14.

### SUMMARY OF THE INVENTION

In view of the shortcomings of the prior art, it is the object of this invention to provide a portable above-ground swimming pool that is capable of insulating the water inside the pool so as to keep desired water temperature for longer hours which results in less energy consumption, reduced overall operating costs, reduced weight, reduced heat loss, and reduced affects of the freeze-thaw cycle.

It is an object of the present invention to provide an above-the-ground swimming pool which is portable, and energy efficient.

The lining material starts with polyester thread. Polyester is durable, strong, and long-lasting. This polyester thread is about the width of a human hair, yet each strand can hold almost 5 pounds of tensile weight. As it is known in the industry, these polyester strands are braided into strands of approximately 1,000 together to create what the industry calls a 1000 denier strand. The threads are then interwoven together into a scrim into a pattern of 18 strands across and 18 up and down (18×18 scrim). Typical water pressure attained in above-ground pools is approximately 250 pounds per square foot.

This poly-reinforced vinyl liner material is so durable it actually resists ripping and tearing. The crisscrossed woven material works much like a chain-link fence. If you cut a couple of links, you can still only open it just a little ways. The resistance is shared by the neighboring links.

This polyester woven core is then encased in several layers of specially formulated UV-treated vinyl coating. This material has proven to be so durable that it is used today with military inflatable boats, giant tents, trucking tarps and blimps. The vinyl is easy to maintain and clean. Liners are typically manufactured in 20 millimeter thicknesses. However, vinyl liners for the above ground pool range from 1 to 30 millimeters depending on the particular application.

There are several embodiments of the invention each with their separate applications. In one embodiment, the above-ground pool can work as a lap pool. In recent years, there has been a greater demand for portable lap pools primarily because of the rising costs of building a traditional style in-ground lap pool. In this application, a lap pool can be installed for about 1/10^{th} the cost of a traditional in-ground lap pool. The typical measurements of a pool of this type when installed above ground is seven feet wide by 28 feet long. The depth of the pool should be seven feet.

Another embodiment in which this invention can be used is for events such as stage productions, photo shoots, and marketing events. Portable Event Pools can be used as sales and marketing tools, or as a project tool. This lining gives the portable pool the ability to make any size, depth and color required.

Yet another embodiment involves the portable pool to be used as a therapy pool. Aquatherapy or warm-water pool therapy consists of an exercise program that is performed in a body of warm water. It is the most beneficial form of therapy in recovering from a variety of medical conditions. While submerged in water, buoyancy assists in supporting the weight of the person. This decreases the amount of weight pressure, reducing the force of stress placed on the body's joints. This aspect of aquatherapy is especially useful for people suffering with arthritis, healing fractured bones and/or other bodily ailments. By decreasing the amount of joint stress it is easier and less painful to perform exercises. Another application of the aquatherapy pool involves pet therapy which includes appropriate depth to accommodate the special needs of animals in addition to a special floating harness which aids the pet during therapy. The special properties of this lining allow the pool to be used for longer periods with less need to add heat to the water because the lining does a better job of conserving heat. Hydrotherapy, formerly called hydropathy involves the use of water for soothing pains and treating diseases. The use of water to treat rheumatic diseases has a long history. It continues to be used as an adjunct to therapy, including in nursing, where its use is now long established. It is used to treat musculoskeletal disorders such as arthritis, ankylosing spondylitis, or spinal cord injuries and in patients suffering burns, spasticity, stroke or paralysis. It is also used to treat orthopedic and neurological conditions in dogs and horses and to improve fitness. These treatments use physical water properties, such as temperature and pressure, for therapeutic purposes, to stimulate blood circulation and treat the symptoms of certain diseases. By retaining heat and thus reducing the need to add heat, this results in reduced operational costs, increased efficiency, reduced environmental impact, and longer use and enjoyment of the pool.

Further objects and advantages of the invention will become apparent to those skilled in the art upon reading and consideration of the following description of a preferred embodiment and the accompanying drawings.

### DETAILED DESCRIPTION OF THE EMBODIMENTS

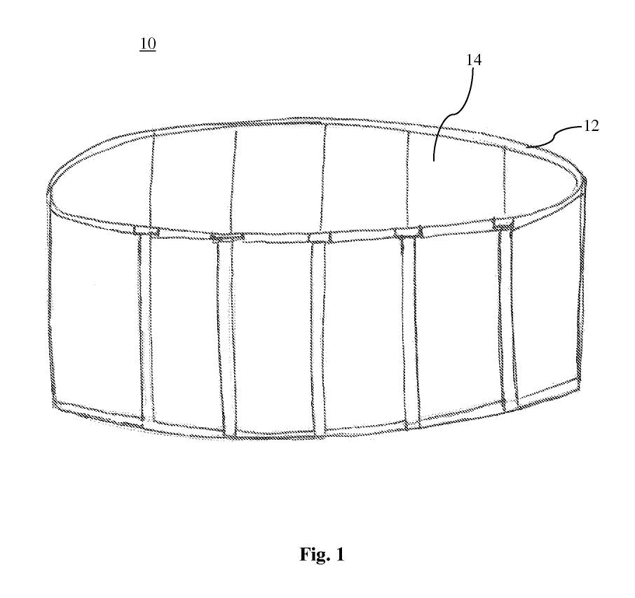

Referring now to the drawings wherein the showings are for purposes of illustrating a preferred embodiment of the present invention and not for purposes of limiting the same, FIG. 1 perspectively illustrates the portable pool assembly 10 of the present invention. Importantly, pool assembly 10 by its design and construction is intended to serve only as an above-the ground pool. Pool assembly 10 generally comprises a frame portion 12 and a liner portion 14 which is adapted to be secured to frame portion 12.

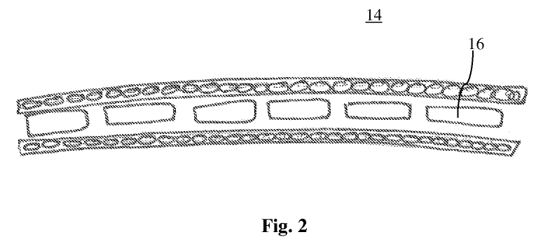

Referring now to FIG. 2, in the preferred embodiment liner 14 is fabricated so as to form a water-retaining basin having a generally circular configuration. As will be appreciated however, the liner and frame portion of the pool may be constructed in a manner so as to have a number of differently shaped configurations, the circular configuration only serving as one embodiment. Additionally, liner 14 is preferably constructed from a polyester inner lining coated with a water-proof vinyl, though it will also be appreciated that a number of different materials may be used in the construction of liner 14.

Advantageously, the aforementioned manner of construction is operable to make liner 14 less susceptible to puncture, leakage or the effects of air and sunlight. Liners are typically manufactured in 20 millimeter thicknesses. However, vinyl liners range from 1 to 30 millimeters depending on the particular application. The liner is configured to allow for an insulating foil-laminated materialized layer 16 to be inserted between two sheets of the water-proof vinyl liner 14.

Any conventional method for bonding vinyl, polyvinyls, or similar materials may be used for example glue, polymer adhesive, heat bonding, ultraviolet crosslinking. In a preferred embodiment the metalized foil layer 16 is inserted between the inner and outer vinyl layer 14 and sealed by means of a radio frequency welder.

The preferred embodiment reduces heat loss compared to non-insulated pools and depending upon the shape and size of the pool can have significant cost savings. This in turn allows for the pool to be used for longer periods with less need to add heat to the water because the lining does a better job of conserving heat. Hydrotherapy, formerly called hydropathy involves the use of water for soothing pains and treating diseases. The use of water to treat rheumatic diseases has a long history. It continues to be used as an adjunct to therapy, including in nursing, where its use is now long established. It is used to treat musculoskeletal disorders such as arthritis, ankylosing spondylitis, or spinal cord injuries and in patients suffering burns, spasticity, stroke or paralysis. It is also used to treat orthopedic and neurological conditions in dogs and horses and to improve fitness. These treatments use physical water properties, such as temperature and pressure, for therapeutic purposes, to stimulate blood circulation and treat the symptoms of certain diseases. By retaining heat and thus reducing the need to add heat, this results in reduced operational costs, increased efficiency, reduced environmental impact, and longer use and enjoyment of the pool.

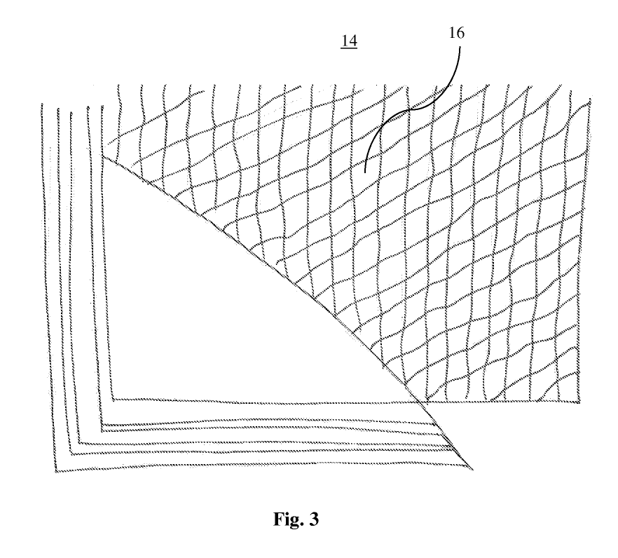

Referring to FIG. 3, it can be seen how the metalized insulating layer 16 is inserted between the inner and outer vinyl layer 14.

The metalized insulating material 16 consists of two 96% reflective layers (reflects 96% of radiant energy) of film bonded to a plurality of internal layers of heavy gage polyethylene bubbles (total thickness 5/16″). The metalized insulating layer 16 is non-toxic and non-carcinogenic. It does not compress, collapse of disintegrate, possesses a Class A fire rating, is durable and lightweight, fiber-free, controls condensation, prevents mold and mildew, and is a vapor and radon retarder. A wide variety of widths and lengths are manufactured.

Foams, fibrous materials, or evacuated spaces (e.g. trapped air) are often used to reduce convective heat transfer by stopping or retarding the movement of fluids (liquids or gases) around the insulated object. Most insulators in common use rely on the principle of trapping air to reduce convective and conductive heat transfer, but not radiative. The quality of such an insulator depends on the degree to which air flow is eliminated (large cells of trapped air will have internal convection currents), the amount of solid material surrounding the air (large percentages of air are better, as this reduces thermal bridging within the insulator), the degree to which the properties of the insulator are appropriate to its use, stability at the temperatures encounters (e.g. softness and flexibility for clothes, hardness and toughness for steam pipe insulation), service lifetime (due to thermal breakdown, water resistance, or resistance to microbial decomposition).

Additional modifications and improvements of the present invention may also be apparent to those skilled in the art. Thus, the particular combination of parts described and illustrated herein in intended to represent only one embodiment of the invention, and is not intended to serve as limitations of alternative devices within the spirit and scope of the invention.

What is claimed:

1. An inner woven reinforced vinyl layer, a second, foil-laminated, metalized layer and a third outer woven reinforced vinyl layer further comprising sealing of all layers together to form a watertight seal.

2. The method for manufacturing an insulated above-ground style pool in which said foil-laminated, metalized layer is entrapped between the inner and outer woven reinforced vinyl layers via radio frequency welding.

3. The method of claim 2 in which the system is used in above-ground pools, vacuums-sealed containers, biological bacterial growth containers, and packages.
